(19) United States
(12) Patent Application Publication
(10) Pub. No.: US 2009/0024908 A1
(43) Pub. Date: Jan. 22, 2009

(54) Method for error registration and corresponding register

(76) Inventors: Thomas Kottke, Ehningen (DE); Andreas Steininger, Wien (AT); Christian El Salloum, Laimgrubengasse (AT)

Correspondence Address: KENYON & KENYON LLP, ONE BROADWAY, NEW YORK, NY, 10004, US

(21) Appl. No.: 11/659,308

(22) PCT Filed: Aug. 1, 2005
(86) PCT No.: PCT/EP05/53730

§ 371 Date: Feb. 2, 2007

(30) Foreign Application Priority Data
Aug. 6, 2004 (DE) 10 2004 038 596.3

(51) Int. Cl. G06F 11/07

(52) U.S. Cl. 714/799; 714/E11.024

(57) ABSTRACT

A method for error registration and a register which is assigned to a dual-computer system, information in the form of bits being stored in the register, the dual-computer system including an error-detection mechanism, and the bits in the register as error bits representing at least one error signal of the error-detection mechanism.

### FIELD OF THE INVENTION

The present invention relates to a method for delaying accesses to data and/or instructions of a dual-computer system, as well as a corresponding delay unit.

### BACKGROUND INFORMATION

In future applications such as, in particular, in the motor vehicle or in the industrial goods sector, thus, e.g., the machine sector and in automation, microprocessor-based or computer-based open-loop and closed-loop control systems will constantly be used more and more for applications critical with regard to safety. In this context, dual-computer systems or dual-processor systems (dual cores) are common computer systems these days for applications critical with regard to safety, particularly in the vehicle such as for antilock braking systems, the electronic stability program (ESP), X-by-wire systems such as drive-by-wire or steer-by-wire, as well as brake-by-wire, etc., or for other networked systems, as well. In order to satisfy these high safety demands in future applications, powerful error mechanisms and error-handling mechanisms are necessary, especially to counter transient errors which occur, e.g., upon reducing the size of the semiconductor structures of the computer systems. At the same time, it is relatively difficult to protect the core, thus the processor, itself. As mentioned, one solution for this is the use of a dual-computer system or dual-core system for error detection. However, one problem when working with such dual-computer systems is that the comparison of data, especially output data for error detection is first carried out upon output or after the output. That is to say, the data are already conducted to an external sink, thus, for example, a component such as a memory or other input/output element, connected via a data bus or an instruction bus, before it is ensured that the data and/or instructions are correct. The result can be that accesses, thus write operations and/or read operations, are made to erroneous data and/or instructions, particularly in the case of errors in memory accesses. Owing to this problem, errors may occur in the restoring of a specific system state, in eliminating the consequences of an error, in the generating of correct data after termination because of an error, in making a system ready again following its breakdown, and, in the case of a circuit configuration, in the return to the original state (which combined, is subsequently denoted as recovery), or this may only be possible at a very high cost. Due to the access in the form of write operations and/or read operations by at least one computer of the dual-computer system, such errors can result in errors in the entire system and units connected to it, which can be so serious that it is not possible to determine which data and/or instructions were erroneously altered.

Dual-processor systems are only able to recognize errors that have occurred, but offer no possibility of effectively handling errors. Since, because semiconductor structures are becoming smaller, the rate of occurrence of transient errors will increase sharply compared to permanent errors, an effective handling of errors will become necessary in order to increase the availability of future systems.

### SUMMARY OF THE INVENTION

An object of the exemplary embodiment and/or exemplary method of the present invention is to solve the problem set forth, and to increase the availability.

The exemplary embodiment and/or exemplary method of the present invention is based on a method for error registration, as well as a register that is assigned to a dual-computer system, information in the form of bits being stored in the register, the dual-computer system containing an error-detection mechanism, the bits in the register as error bits advantageously representing at least one error signal of the error-detection mechanism; and a corresponding dual-computer system.

The register is expediently arranged or provided so that the error-detection mechanism is able to set a corresponding error bit, and this error bit is erasable again by the dual-computer system, the register being contained in one computer of the dual-computer system or being superimposed into the memory area of one computer of the dual-computer system.

Advantageously, an error bit is set in the register only on the basis of a first error. It is further expedient that a plurality of error signals are combined to form one unified error signal, and that an interrupt is triggered by the unified error signal.

One register is advantageously provided for each computer in a dual-computer system; in one specific embodiment, the two computers of the dual-computer system operate with a clock-pulse offset, and the error bit is set in the registers using this clock-pulse offset, as well.

Advantageously, one register is provided for each computer and one interrupt is triggered by each unified error signal, the interrupts being triggered with the clock-pulse offset; in the method for error registration in a dual-computer system, upon detection of an error, at least one error bit is stored in the register and the at least one register is evaluated, and an error-handling routine is carried out as a function of the position of the error bit in the register, or the at least one register is evaluated and an error-handling routine is carried out as a function of the error bits in the register, and after an error-handling routine, the register is reset or erased.

Further advantages and advantageous refinements are derived from the description of the exemplary embodiments, as well as from the features in the claims.

### BRIEF DESCRIPTION OF THE DRAWINGS

FIG. 1 shows a dual-computer system or dual-processor system having a delay unit according to the exemplary embodiment and/or exemplary method of the present invention.

FIG. 2 shows a first specific embodiment of a delay unit according to the exemplary embodiment and/or exemplary method of the present invention.

FIG. 3 shows a second specific embodiment of a delay unit according to the exemplary embodiment and/or exemplary method of the present invention.

FIG. 4 shows a multiplex component, in particular a safe (secure) multiplexer of a delay-unit according to the exemplary embodiment and/or exemplary method of the present invention.

FIG. 5 shows a register for error registration, as well as its functioning.

### DETAILED DESCRIPTION

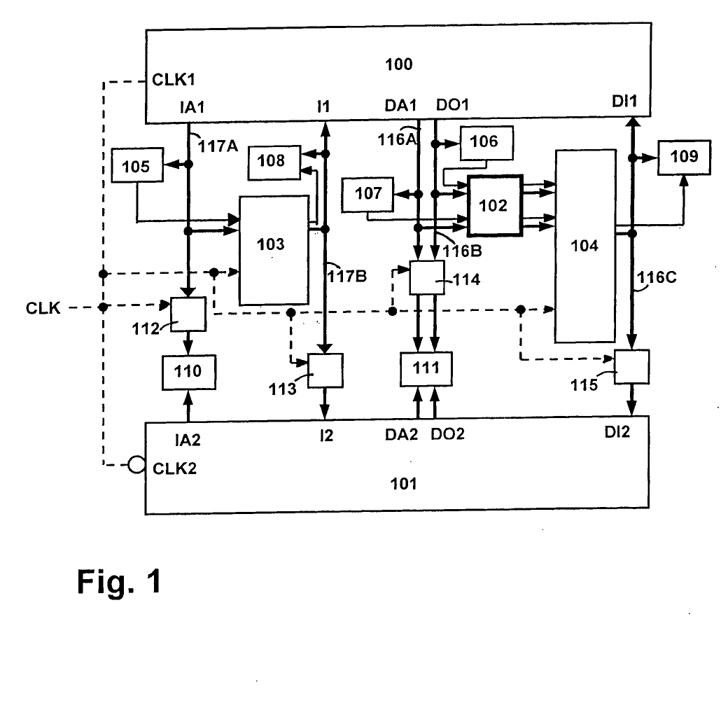

FIG. 1 shows a dual-computer system having a first computer 100, in particular a master computer, and a second computer 101, in particular a slave computer. The entire system is operated with a specifiable clock pulse or in specifiable clock cycles CLK. The clock pulse is supplied via clock input CLK1 of computer 100 to said computer, and via clock input CLK2 of computer 101 to that computer. Moreover, in this dual-computer system, a special feature for error detection is included by way of example, in which, namely, first computer 100 and second computer 101 operate with a time offset, especially a specifiable time offset or a specifiable clock-pulse offset. In this context, any desired time is specifiable for a time offset, and also any desired clock pulse with regard to an offset of the clock cycles. This may be an integer offset of the clock cycle, but also exactly as shown in this example, e.g., an offset of 1.5 clock cycles, first computer 100 operating or, more precisely, being operated here precisely 1.5 clock cycles before second computer 101. This offset prevents common mode errors from similarly disturbing the computers or processors, thus the cores of the dual core system, and therefore remaining undetected. That is to say, due to the offset, such common mode errors affect the computers at different points of time in the program run, and accordingly result in different effects with respect to the two computers, which means errors become detectable. Without a clock-pulse offset, substantially identical error effects would possibly not be detectable in a comparison; this is thereby avoided. Offset modules 112 through 115 are implemented in order to accomplish this offset with respect to the time or the clock pulse, here in particular 1.5 clock cycles, in the dual-computer system.

To detect the indicated common mode errors, this system is designed, for example, to operate in a predefined time offset or clock-cycle offset, in particular here, 1.5 clock cycles; that is to say, while the one computer, e.g., computer 100 addresses the components, especially external components 103 and 104, directly, second computer 101 operates with a delay of exactly 1.5 clock cycles relative thereto. In this case, in order to produce the desired 1½ cycle delay, thus, 1.5 clock cycles, computer 101 is fed with the inverted clock, i.e., the inverted clock pulse at clock input CLK2. Consequently, however, the aforesaid connections of the computer, thus its data and instructions, respectively, via the buses must also be delayed by the indicated clock cycles, thus here in particular 1.5 clock cycles, for which in fact offset or delay modules 112 through 115 are provided, as said. In addition to the two computers or processors 100 and 101, components 103 and 104 are provided, which are connected to the two computers 100 and 101 via bus 116, made up of bus lines 116A, 116B and 116C, as well as bus 117, made up of bus lines 117A and 117B. In this context, 117 is an instruction bus, in which 117A denotes an instruction address bus and 117B denotes the sub-instruction(data) bus. Address bus 117A is connected via an instruction address connection IA1 (Instruction Address 1) to computer 100, and via an instruction address connection IA2 (Instruction Address 2) to computer 101. The instructions themselves are transmitted via sub-instruction bus 117B, which is connected via an instruction connection I1 (Instruction 1) to computer 100, and via an instruction connection I2 (Instruction 2) to computer 101. A component 103, e.g., an instruction memory, particularly a safe instruction memory or the like, is interposed in this instruction bus 117 made up of 117A and 117B. This component, especially as an instruction memory, is also operated with clock pulse CLK in this example. Moreover, 116 represents a data bus which includes a data address bus or a data address line 116A and a data bus or a data line 116B.

In this case, 116A, thus, the data address line, is connected to computer 100 via a data address connection DA1 (Data Address 1), and to computer 101 via a data address connection DA2 (Data Address 2). In the same way, the data bus or data line 116B is connected via a data connection DO1 (Data Out 1) and a data connection DO2 (Data Out 2) to computer 100 and computer 101, respectively. Data bus 116 also includes data bus line 116C, which is connected via a data connection DI1 (Data In 1) and a data connection DI2 (Data In 2) to computer 100 and computer 101, respectively. A component 104, e.g., a data memory, especially a safe data memory or something similar, is interposed in this data bus 116 made up of lines 116A, 116B and 116C. In this example, this component 104 is also supplied with clock pulse CLK.

In this context, components 103 and 104 stand for any components which are connected via a data bus and/or instruction bus to the computers of the dual-computer system, and according to the accesses by way of data and/or instructions of the dual-computer system in terms of write operations and/or read operations, can receive or output erroneous data and/or instructions. To avoid errors, error-identifier generators 105, 106 and 107 are in fact provided, which generate an error identifier such as a parity bit or also another error code such as an error correction code, thus ECC or something similar. In addition, the corresponding error-identifier check devices 108 and 109 are then also provided to check the respective error identifier, thus, e.g., the parity bit or another error code such as ECC.

The comparison of the data and/or instructions in terms of the redundant design in the dual-computer system takes place in comparators 110 and 111 as shown in FIG. 1. However, if a time offset, particularly a clock-pulse offset or clock-cycle offset, now exists between computers 100 and 101 caused either by a non-synchronous dual-processor system or, in the case of a synchronous dual-processor system, by errors in the synchronization or also, as in this special example, by a time offset or clock-cycle offset, especially here of 1.5 clock cycles, desired for detecting errors, then during this time offset or clock-pulse offset, a computer, here in particular computer 100, can read or write erroneous data and/or instructions in components, especially external components such as here, in particular, memory 103 or 104, but also with respect to other users or actuators or sensors. Thus, it may also erroneously perform a write access instead of a provided read access due to this clock-pulse offset. Naturally, these scenarios lead to errors in the entire system, particularly without clear possibility of indicating which data and/or instructions were just erroneously altered, whereby the recovery problem also arises.

To solve this problem, as shown, a delay unit 102 is now switched into the lines of the data bus and/or into the instruction bus. For reasons of clarity, only the switching into the data bus is shown. Naturally, this is equally possible and conceivable with respect to the instruction bus. This delay unit 102 delays the accesses, here especially the memory accesses, so that a possible time offset or clock-pulse offset is compensated, particularly in the case of an error detection, e.g., via comparators 110 and 111, at least, for instance, until the error signal is generated in the dual-computer system, thus the error detection is performed in the dual-computer system. Different variants may be implemented for this purpose:

Delay of the write operations and read operations; delay only of the write operations; or also, even though not preferred, a delay of the read operations. In this context, a delayed write operation can be converted into a read operation by a change signal, in particular the error signal, in order to prevent erroneous writing.

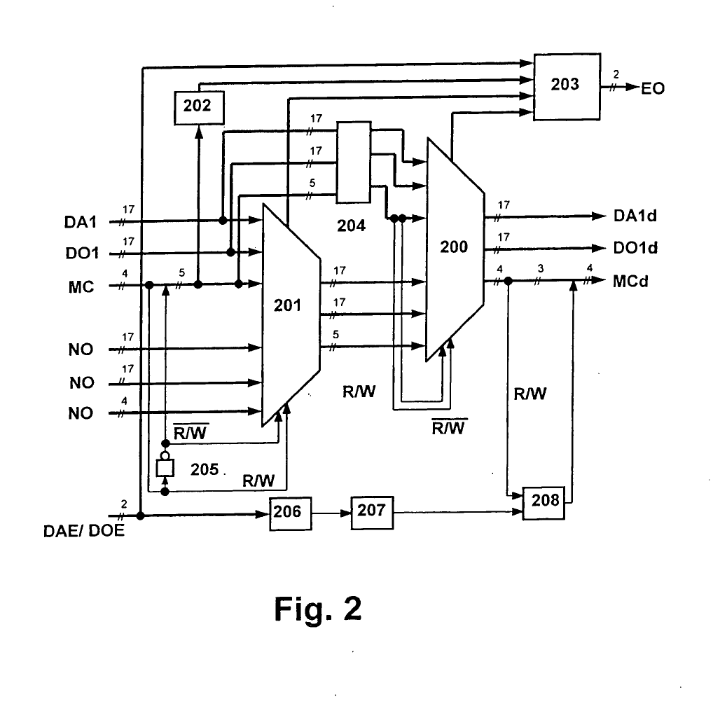

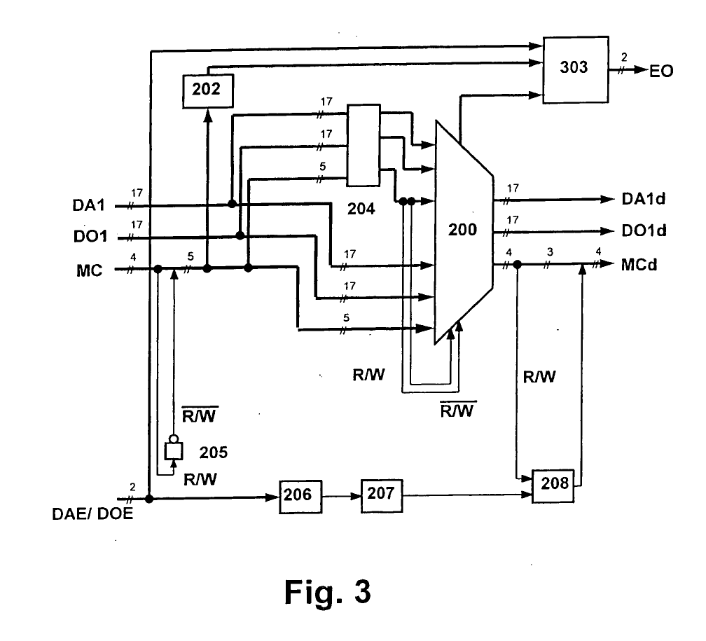

Various ways of implementing delay unit 102 are shown in FIGS. 2 and 3. The purpose of delay unit, i.e., delay unit 102, is to delay accesses within the framework of the indicated time offset or clock-cycle offset in order to compensate for them, particularly in order to achieve write operations of computer 100 to a component, especially an external component, up to the checking and therefore correctness of the corresponding data and/or instructions and the respective addresses. In this context, the delay unit may also be implemented in a manner that it detects errors in itself and signals this to the outside by an error signal EO; this is explained in greater detail again with reference to FIGS. 2 and 3.

FIG. 2 now shows a delay unit having two switchover modules 201 and 200, in particular multiplex modules, a delay element 204 and a checking device or test device 203, in particular a TSC checker. The delay unit is made up of two branches, a read branch that corresponds to the lower input path of multiplexer 200 (the lower three arrows) including multiplexer 201, and a write branch, thus the upper input path of multiplexer 200 (the upper three arrows). That is to say, especially when it is only intended to delay write operations, the delay unit is made up of two paths, between which it is possible to switch using a switchover device, in particular a multiplexer 200. In the one path, the data and/or instructions, here the data of DO1 (Data Out 1), the corresponding addresses, here DA1 (Data Address 1) and here in particular, additionally memory control signals MC, pass through undelayed; in the other branch, they are delayed by delay element 204. The switchover between the two paths is accomplished by a switchover signal, particularly write/read signal R/W or its inversion, thus a signal invert R/W derived therefrom (= ^{R̅/̅W̅}=R/W with the mark above it in FIGS. 2 through 4).

In the write branch, thus the branch having delay element 204, given a predefined delay of 1.5 clock cycles as described above, a delay by two clock cycles is implemented, for instance, and is therefore longer than the necessary minimum of 1.5 clock cycles, thereby allowing a memory to be operated using the same clock input CLK. That is to say, the delay is at least as great as the time offset provided (here 1.5 clock cycles), but may also be greater as in this example. To produce consistency, the associated address signals and control signals are equally delayed. As said, this is just as conceivable for the instruction bus as it is possible for the data bus (as shown by way of example for the data bus with DA1 and DO1). Therefore, the representation would easily be transferable to an instruction bus for IA1.

The bit numbers at the individual connections in FIGS. 2 and 3 are selected by way of example, i.e., a 16-bit system plus. one parity bit (16 bits+1 parity=17 bits) is proposed here in this example. A transfer to other bit widths such as 8, 32, 64 bits plus parity bit or wider error identifiers is possible without difficulty and may be done according to the exemplary embodiment and/or exemplary method of the present invention. In the same way, the selection of 4 bits for memory control signal MC is by way of example. The number 5 bits due to the additionally coupled-in R/W invert bit to then precisely 5 bits (4 bits+1 R/W invert=5 bits) is to be regarded as exemplary, as well. In the lower input branch of switchover module 200 (the lower three arrows and switchover module 201 included here), the delay is bypassed by switchover device (module) 200, controlled by a switchover signal (particularly by using write/read signal R/W or the invert R/W derived therefrom). When utilizing R/W (write/read signal), it is turned into the inverted write/read signal by inversion element 205. Second switchover module 200, in particular the second multiplexer. which brings the data and/or instructions (here, illustratively, the data) together again, is likewise controlled by this signal, particularly write/read signal R/W and its inversion. As described below, in this context, the signal is advantageously to be extracted from the delayed path, thus, downstream of delay element 204.

Thus, delayed write/read signal R/W or invert−R/W (= ^{R̅/̅W̅}) inverted therefrom is expediently selected, because otherwise an access, particularly a write access, would possibly be initiated without reaching the desired delay of, illustratively here, two clock cycles before the other connected signals are present. This could lead to problems in a switchover between read access and write access. For example, if a read access (a read operation) is carried out directly after a write access (a write operation), the delayed write access and the read access directly following it would have to be carried out in parallel. That is to say, there should not be an exact interval of 2 clock pulses between a write operation and a following read operation; i.e., it is easier to realize if a minimum interval of, here, two clock cycles takes place between a write operation and a following read operation. In the case of a write operation, a void of the duration of the write operation occurs at the output of switchover module 200. During this void, switchover module 200, thus the multiplexer, would activate the read branch, thus the three lower inputs of multiplexer 200, the undelayed data and addresses and control information of this branch still being part of the write operation. To prevent this information, thus the preceding operation, from reaching the bus, switchover device 201 is provided which, in this case, supplies uncritical constants, e.g., the No operation NO, as shown here in FIG. 2, to the lower input of multiplexer 200 while this waiting time exists, until multiplexer 200 possibly switches to the three upper input paths, thus the delayed input paths and carries out the current write operation. In this case, to protect the interfaces with respect to other components, in this example, the signals data address DA1, data out DO1 and memory control MC are each protected by a single parity bit. This parity is protected by check units 109 and 108, respectively, for the instruction bus, whereas memory control signal MC is protected by an additional memory checker 202 not shown in FIG. 1. The parity bit of this signal MC is delayed by delay element 204 in like manner as the remaining signals. Since the signals of each signal type DA1, DO1 and MC are conducted independently in the delay unit, this single parity bit permits sufficient protection against single errors. As already said, in the case of multi-error detection or protection, as well as correction of multiple errors, more powerful error identifiers may be used.

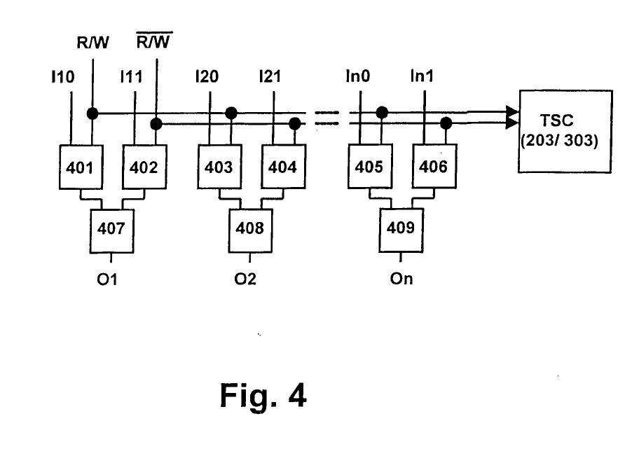

Since the switchover signal or change signal, thus here write/read signal R/W, fills a special role for controlling the switchover units, the intention is to specifically protect it again in a special design. This is to take place through a dual rail code (thus on two tracks (levels)) directly at the input into the delay unit; this is described again in greater detail with reference to FIG. 4.

An additional function may be realized via path DAE/DOE, 206, 207 and 208. A protection of write operations is attainable via it in the event of an error when working with standard components such as a failsafe memory, or just as in the switchover of a write operation to a read operation. Error signal DAE/DOE of the dual core is present as dual rail code. It is converted into a single-rail signal and specifically before there is a time delay in between. This takes place in a compare module 206 which, in particular, may be implemented as an XOR module. At the same time, XOR element 206 makes a single signal out of the multiple signal. Optionally, a time delay of 0.5 clock cycles is now included in a delay element 207 in order to attain a temporal alignment of the resulting error signal with the corresponding data word in the delay unit. This is done, since in our example, the delay unit delays by two clock cycles according to delay element 204. If, for example, an AND gate is then used as block 208, write/read signal R/W can be masked in order to block a write access as shown in connection with the configuration of block 208.

Like the parity bit of the memory control MC from 202, as well as the respective switchover or change signal of switchover devices 201 and 202, thus, in particular, write/read signal R/W and the inverse write/read signal (invert R/W) derived therefrom), this DAE/DOE input, thus the error signal from the computers, may likewise be supplied to test module 203 (particularly in the form of a TSC checker), from which an error signal EO (error out) results which is usable for further error handling. As already mentioned, the use of write/read signals R/W and ^{R̅/̅W̅} for the switchover in the multiplexer as well as their checking are explained in greater detail in FIG. 4.

After the executions, obtained now at the output in the delay unit according to FIG. 2 are an either undelayed or delayed data address signal DA1d (Data Address delayed), an either undelayed or delayed data signal or data output signal DO1d (Data Out delayed) as a function of a read operation or write operation, and, in this special example if a memory module is used as component, especially external component, a memory control signal MCd (Memory Control delayed) that is likewise either undelayed or delayed.

FIG. 3 now once again shows a delay unit in a second specific embodiment; as shown, the delay unit may also be implemented using-only one switchover module or multiplexer 200 and two branches. In this case, only second multiplexer 200 from FIG. 2 is used, so that inputs DA1, DO1 and MC are fed directly to it. As before, the same inputs are already delayed via a delay element 204 and likewise fed to multiplexer 200. In this context, the data (thus here data address DA1, data DO1 and memory control MC) go simultaneously into both branches, write operations in the undelayed path being converted into read operations. This change or switchover of the write operations into read operations may likewise be accomplished by write/read signals R/W or the R/W inverted signal derived therefrom.

Incidentally, the design of the second specific embodiment is comparable to the first specific embodiment except for the fact that first multiplexer 201 was omitted, which means, to the extent present, the designations and the functions are also identical. The exception is the test unit, since due to the absence of multiplexer 201, it receives fewer signals and may therefore be constructed slightly differently, and thus is denoted here by 303. However, it likewise outputs usable error signal EO, which may be further used in the framework of error handling.

Particularly when using a von Neumann architecture in which the component is appended to a general bus, it is advantageous if only the write operation is delayed The instruction-memory accesses and the read operations are expediently carried out without delay within the framework of the von Neumann architecture.

In the case of the delay unit, safe multiplexers according to FIG. 4 may be used as switchover modules or multiplexers. In this case, the data are protected by an error-detection code, here, e.g., a parity bit, and the control signals, thus the switchover or change signals, here in particular write/read signal R/W and inverse write/read signal R/W derived therefrom, are protected as well, here in dual rail logic by way of example. That is to say, the R/W and the inverse signal are first supplied to the safe multiplexer, and from there to the test unit, TSC checker 203 or 303. Under these stipulations, an error which involves one track (level) of the write/read signal is detected by test unit TSC 203 or 303, while a single error in the multiplex circuit will involve a single output bit and is therefore ascertainable by the parity check. That is, as explained before, the data and/or instructions are switched over as in a standard multiplexer, the parity bit or another error identifier additionally being switched over. The control signals, thus switchover or change signals R/W and R/W invert are initially carried to all changeover switches for the individual bits, represented here in modules 401 through 406 in particular as AND gates, to which respective inputs I10, I11, I20, I21 through In0, In1 are supplied, as well. The modules or their output signals from 401-406 are then in each case combined in modules 407 through 409 as shown in FIG. 4. To that end, modules 407-409 are realized in particular as OR gates. Outputs of multiplex module O1, O2 through On are then obtained. The structure illustrated in FIG. 4 is only one segment from the total structure of a multiplex module according to FIGS. 2 and 3 having the bit widths of 17 bits or 5 bits per signal path shown therein by way of example. That is, both multiplex modules 201 and 200 according to FIGS. 2 and 3 are advantageously realized in the form of FIG. 4 in order, as already described, to make a mistakenly switched data path recognizable and to simplify the error identification. Such errors could not be ascertained by pure parity checking, since the data of the false signal path also have the correct parity, provided no bit dropout is present.

This safety package is completed by the protection of the interface to a component, particularly an external component according to 103 and 104 from FIG. 1, in that, as already shown in FIG. 1, error-identifier units for generating the error identifier 105-107 and error checking units for checking the error identifier like 108 and 109 are provided in particular as parity bit checkers and parity bit generators. The error signals formed in this context may then also be used exactly as DAE/DOE signals according to FIG. 2 and FIG. 3 as data address error or data out error in the delay module, as described. Thus, by the use of a safe multiplexer, in which the control signals, i.e., switchover or change signals R/W and R/W invert are first carried to all changeover switches for the individual bits, and only after that checked in the TSC checker, errors in the control signals can be detected by testing them or, if only one bit is switched over erroneously, this is detected by the data coding of the data to be switched over.

Therefore, the exemplary embodiment and/or exemplary method of the present invention permits a considerable increase in safety within the framework of a dual-computer system, using a relatively efficient arrangement.

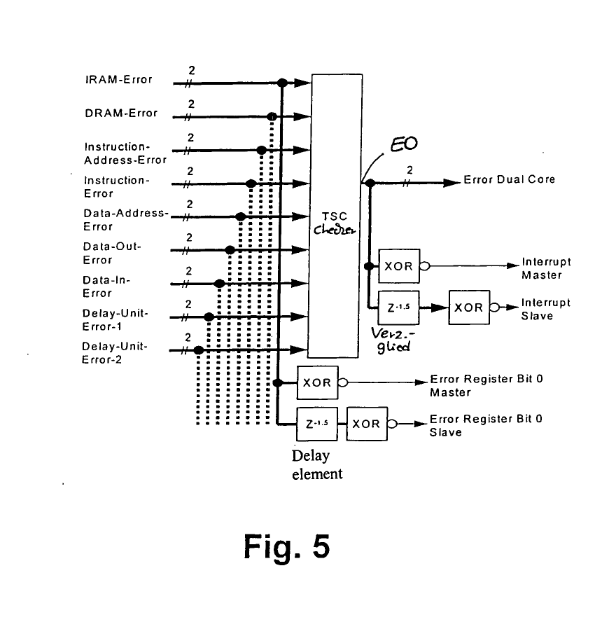

Finally, FIG. 5 shows the functioning method of the register, in particular the error register.

Today's dual-computer systems for error detection (e.g.: dual core) offer a very high error-discovery probability. Since the number of transient errors is increasing because of new semiconductor technologies with ever smaller structure widths, most errors could be eliminated by an error-handling routine. In present-day dual-processor systems, often only the occurrence of one error is registered, and the system is then shut off or restarted by a reset. This error-handling method requires a long period of time. To accelerate the recovery from errors, the software on the computer must know the error location so that a targeted and rapid elimination of the error may be accomplished.

If the error locations are specified through different interrupt lines, then the interrupt controller must be designed to be error-tolerant (fault tolerant), or many interrupt lines would also have to be available accordingly. This is also because the error-discovery mechanisms are not intelligent interrupt sources which could possibly also supply an identifier.

To make this possible, an error register is provided here, which is incorporated in each of the two processors of the dual-computer system. This register does not necessarily have to be addressable like a register in the processor, but may also be superimposed in a memory area of the processor. Each bit of the error register represents the error signal of one error-discovery mechanism of the dual-processor system. This is shown here by way of example for one implementation (image 1). In this context, here bits (A) through (H) accordingly represent:

(A) Instruction-memory error: e.g., a parity error in the instruction address.

(B) Data-memory error, can also be represented by 2 bits.

One, for instance, for errors in the address and the other for errors in the data.

C) Instruction-address error: detected by a comparator.

D) Instruction error: The instruction is falsified. Is detected, for example, by a parity test of the instruction.

E) Data-address error: like (C), is detected by a comparator.

(F) Data-word error: Detection like (C) or (D).

(G) An exemplary additional component having an error-detection mechanism.

(H) Input-data error: Error can be detected, for example, by a parity test as in point (D).

The functioning method of the error register is shown by way of example in image 2. If an error now occurs, the corresponding error bit is first set in the error register of the master (error register bit 0 master) and 1.5 clock pulses later in the error register of the slave (error register bit 0 slave). This delay is necessary, since in this exemplary implementation, the two processors operate with a clock-pulse offset of 1.5 clock pulses. The implementation may be used in the same way for dual-processor systems having a different clock-pulse offset from 0 to x (x from the natural numbers). In this connection, the signal for the second processor must be delayed accordingly. The error signals are present here as dual-rail signals. However, this is not absolutely requisite. In addition, all single-error signals are combined to form one total signal. Using this combined signal (error dual core), it is possible to trigger an interrupt at the dual-processor system. The interrupt is first triggered at the master (interrupt master), and with the suitable clock-pulse offset at the slave (interrupt slave). The delay at the slave in the amount of the clock-pulse offset is necessary to ensure the synchronism of the dual-processor system even in the case of an error and during the error-handling routine.

Because of this interrupt, the error register of the master can now be read out by the master, and the error register of the slave by the slave. By evaluating the set bit, it is now possible to start an error-handling routine. After the error-handling routine has concluded, the corresponding bit can/should be reset.

The error register does not have to have an error-tolerant design, since it is implemented individually for each processor. If an error occurs in one register, then the two processors diverge in an error-handling routine (carry out different recovery measures), and therefore errors are detected in this register. If there is only one error register, it likewise does not have to be implemented to be error-tolerant, since in the case of an error, both one bit must be set in this register, and an interrupt must also be triggered. If the interrupt is triggered and the bit is not set or two bits are set, an error has occurred in the error register.

The error register or error-register pair may be used not only in dual-processor systems. It is usable in x-fold processor systems, as well, where x can be from 1 to infinity. Shown are:

(1) An error register in which each bit represents an error signal of an error-detection mechanism.

(2) An error register in which the error-detection mechanisms of the processor system are able to set the corresponding error bit, and it can be erased again by the processor, and which is implemented as a processor register or is superimposed into the memory area of the processor.

(3) An error-register pair in a dual-processor system in which the error register is explicitly provided for each processor.

(4) An error-register pair in which the error register of the master is set upon occurrence of the error, and the error register of the slave is set with the suitable clock-pulse offset.

(5) A combining of the single-error signals to form one unified error signal by which an interrupt can be triggered.

(6) Like 5, but in which the interrupts at the master and slave are triggered with a clock-pulse offset to ensure the synchronism of the dual-processor system.

(7) An error register in which only the first occurring error is allowed to set a bit.

A method

(1) in which each error-detection mechanism is represented by one bit/symbol, and which sets it upon detection of an error;

(2) in which the register is evaluated, and a special error-handling routine corresponding to the bit is carried out;

(3) in which simultaneously upon detection of the error, the bit is set in the register/register pair, and an interrupt is triggered at the single-processor, dual-processor or multiprocessor system;

(4) in which after an error-handling routine, the register is reset again by the processor.

1-18. (canceled)

19. A register which is assigned to a dual-computer system, comprising:
a register arrangement storing information in the form of bits, wherein the dual-computer system includes an error-detection arrangement, and wherein the bits in the register include error bits representing at least one error signal of the error-detection arrangement.

20. The register of claim 19, wherein the error-detection arrangement can set a corresponding error bit that is erasable by the dual-computer system.

21. The register of claim 19, wherein the register is contained in one computer of the dual-computer system.

22. The register of claim 19, wherein the register is superimposed into a memory area of one computer of the dual-computer system.

23. The register of claim 19, wherein an error bit is set in the register only on the basis of a first error.

24. The register of claim 19, wherein a plurality of error signals are combined to form one unified error signal.

25. The register of claim 24, wherein an interrupt is triggered by the unified error signal.

26. A dual-computer system comprising:
at least one register assigned to the dual-computer system, the register storing information in the form of bits; and
an error-detection arrangement,
wherein the bits in the register include error bits representing at least one error signal of the error-detection arrangement.

27. The dual-computer system of claim 26, wherein the at least one register includes one register is provided for each computer.

28. The dual-computer system of claim 27, wherein the two computers of the dual-computer system operate with a clock-pulse offset, and the error bit is set in the registers using this clock-pulse offset.

29. The dual-computer system of claim 26, wherein error signals are combined to form one unified error signal.

30. The dual-computer system of claim 26, wherein an interrupt is triggered by the unified error signal.

31. The dual-computer system of claim 27, wherein one register is provided for each computer, and one interrupt is triggered by each unified error signal, the interrupts being triggered using the clock-pulse offset.

32. A method for providing error registration in a dual-computer system, the method comprising:
storing information in the form of bits in a register, wherein the dual-computer system includes an error-detection arrangement, and the bits in the register include error bits representing at least one error signal of the error-detection arrangement;
detecting an error; and
storing, upon detection of the error, at least one of the error bits in the register.

33. The method of claim 32, wherein the at least one register is evaluated, and an error-handling routine is performed as a function of a position of the error bit in the register.

34. The method of claim 32, wherein the at least one register is evaluated, and an error-handling routine is performed as a function of the error bits in the register.

35. The method of claim 32, wherein an interrupt is triggered by at least one of the error bits in the register.

36. The method of claim 32, wherein after an error-handling routine, the register is one of reset and erased.
